(19) United States
(12) Patent Application Publication
(10) Pub. No.: US 2011/0238263 A1
(43) Pub. Date: Sep. 29, 2011

(54) PREVENTING CONDENSATION ON THE SURFACE OF MOVING VEHICLES

(75) Inventor: Kenichi FUSE, Hadano-shi (JP)

(73) Assignee: EMPIRE TECHNOLOGY DEVELOPMENT LLC, Wilmington, DE (US)

(21) Appl. No.: 12/963,732

(22) Filed: Dec. 9, 2010

(30) Foreign Application Priority Data
Mar. 23, 2010 (JP) 2010-066464

(51) Int. Cl. G06F 19/00

(52) U.S. Cl. 701/36

(57) ABSTRACT

A system and method for controlling condensation on the windshield of a vehicle caused by a difference in environments inside and outside of a tunnel. The system and method include a tunnel information acquisition section acquiring a dew point D or a saturated vapor density V in the tunnel; a vehicle information acquisition section acquiring a temperature Tf around an outer surface of a windshield of the vehicle or a vapor density Vf around the outer surface of the windshield of the vehicle outside the tunnel; and a control section controlling the device so as to perform a prescribed operation when the temperature Tf is equal to or less than the dew point D or when the vapor density Vf is at least the saturated vapor density V.

### CROSS-REFERENCE TO RELATED APPLICATIONS

This application claims priority to Japanese Patent Application No. 2010-066464 filed Mar. 23, 2010, which is incorporated herein by reference in its entirety.

### TECHNICAL FIELD

Embodiments disclosed herein relate to a technique of controlling devices mounted on a vehicle for preventing an occurrence of condensation on the vehicle.

### BACKGROUND

In recent years, vehicles have become more intelligent, and various devices for supporting driving the vehicles have been developed and implemented. For example, vehicles are known that include a device that automatically operates a windshield wiper on sensing raindrops and a device that recognizes a lane of a road by an onboard camera and that displays an alarm when the vehicle deviates from the lane.

When the vehicle enters a tunnel, there is a possibility of causing instantaneous condensation on the outer surface of a windshield owing to a difference between the environments of the outside and inside of the tunnel. Occurrence of the condensation on the outer surface of the windshield may interfere with a field of front vision of a driver, possibility causing an accident.

However, conventional vehicles have not been mounted with a device that supports driving when condensation instantaneously occurs. Moreover, no investigation has been made of such a support technique.

### BRIEF SUMMARY

A control system according to the embodiments disclosed herein is a control system of a device mounted on a vehicle The control system includes: a tunnel information acquisition section acquiring a saturated vapor density V in an environment in a tunnel where the vehicle can travel; a vehicle information acquisition section acquiring a vapor density Vf around an outer surface of a windshield of the vehicle in an environment outside the tunnel; a control section controlling the device so as to perform a prescribed operation when a vapor density Vf is at least the saturated vapor density V; and an onboard temperature sensor and an onboard humidity sensor disposed around an outer surface of the windshield of the vehicle. The vehicle information acquisition section acquires a temperature Tf around the outer surface of the windshield of the vehicle on the basis of sensor data from the onboard temperature sensor and acquires a humidity Hf around the outer surface of the windshield of the vehicle on the basis of sensor data from the onboard humidity sensor before the vehicle enters the tunnel, and calculates a vapor density Vf on the basis of the temperature Tf and the humidity Hf. The tunnel information acquisition section acquires a temperature Tt in the tunnel on the basis of the sensor data from the onboard temperature sensor and acquires the saturated vapor density V on the basis of the temperature Tt when the vehicle enters the tunnel. The device includes at least one of a windshield wiper driver related to the windshield of the vehicle, a windshield washer fluid ejector related to the windshield of the vehicle, and an alarm device for an occupant of the vehicle.

A control system according to the embodiments disclosed herein is a control system of a device mounted on a vehicle. The control system includes: a tunnel information acquisition section acquiring a dew point D in an environment in the tunnel where the vehicle can travel or a saturated vapor density V in the environment in the tunnel; a vehicle information acquisition section acquiring a temperature Tf around an outer surface of a windshield of the vehicle in an environment outside the tunnel or a vapor density Vf around the outer surface of the windshield of the vehicle in the environment outside the tunnel; and a control section controlling the device so as to perform a prescribed operation when the temperature Tf is equal to or less than the dew point D or when the vapor density Vf is at least the saturated vapor density V.

The tunnel information acquisition section can acquire a temperature Tt and a humidity Ht in the tunnel, and calculate the dew point D on the basis of the temperature Tt and the humidity Ht. In this case, the control system can include an in-tunnel temperature sensor and an in-tunnel humidity sensor disposed in the tunnel; and a transmitting unit transmitting sensor data of the in-tunnel temperature sensor and the in-tunnel humidity sensor such that the tunnel information acquisition section can acquire the sensor data. The tunnel information acquisition section can acquire the sensor data transmitted from the transmitting unit, and acquire the temperature Tt and the humidity Ht on the basis of the sensor data.

The tunnel information acquisition section can acquire a temperature Tt in the tunnel, and calculate the saturated vapor density V on the basis of the temperature Tt. In this case, the control system can further include: an in-tunnel temperature sensor disposed in the tunnel; and a transmitting unit transmitting sensor data from the in-tunnel temperature sensor such that the tunnel information acquisition section can acquire the sensor data. The tunnel information acquisition section can acquire the sensor data transmitted from the transmitting unit, and acquire the saturated vapor density V on the basis of the sensor data.

The control system can further include an onboard temperature sensor and an onboard humidity sensor disposed around an outer surface of the windshield of the vehicle. The vehicle information acquisition section acquires a temperature Tf around an outer surface of the windshield of the vehicle on the basis of sensor data from the onboard temperature sensor and acquires a humidity Hf around the outer surface of the windshield of the vehicle on the basis of sensor data from the onboard humidity sensor before the vehicle enters the tunnel, and calculates a vapor density Vf on the basis of the temperature Tf and the humidity Hf. In this case, the tunnel information acquisition section can acquire a temperature Tt in the tunnel on the basis of the sensor data from the onboard temperature sensor and acquire the saturated vapor density V on the basis of the temperature Tt when the vehicle enters the tunnel.

The control system can further include an onboard temperature sensor and an onboard humidity sensor disposed around an outer surface of the windshield of the vehicle. The vehicle information acquisition section can acquire a temperature Tf around the outer surface of the windshield of the vehicle on the basis of sensor data from the onboard temperature sensor before the vehicle enters the tunnel, and the tunnel information acquisition section can acquire a temperature Tt in the tunnel on the basis of the sensor data from the onboard temperature sensor and acquire a humidity Ht in the tunnel on the basis of the sensor data from the onboard humidity sensor and calculate the dew point D on the basis of the temperature Tt and the humidity Ht when the vehicle enters the tunnel.

The control system can further include a database storing data of the dew point in the tunnel that is preliminarily measured or storing data of a temperature and a humidity in the tunnel that is preliminarily measured. The tunnel information acquisition section can acquire the dew point D on the basis of data read from the database.

The control system can further include a database storing data of the saturated vapor density in the tunnel that is preliminarily measured or storing data of a temperature in the tunnel that is preliminarily measured. The tunnel information acquisition section can acquire the saturated vapor density V on the basis of data read from the database.

The device can include at least one of a windshield wiper device related to the windshield of the vehicle, a windshield washer fluid ejector related to the windshield of the vehicle, and an alarm device notifying an alarm to an occupant of the vehicle.

A vehicle according to the embodiments disclosed herein is a vehicle including a control system and a control target device. The vehicle includes a tunnel information acquisition section acquiring a dew point D in an environment in the tunnel where the vehicle can travel or acquiring a saturated vapor density V in the environment in the tunnel; a vehicle information acquisition section acquiring a temperature Tf around an outer surface of a windshield of the vehicle in an environment outside the tunnel or acquiring a vapor density Vf around the outer surface of the windshield of the vehicle in the environment outside the tunnel; and a control section controlling the control target device so as to perform a prescribed operation when the temperature Tf is equal to or less than the dew point D or when the vapor density Vf is at least the same as the saturated vapor density V.

A control method according to the embodiments disclosed herein is a control method for a device mounted on a vehicle as a control target, including: acquiring a dew point D in an environment in the tunnel where the vehicle can travel or a saturated vapor density V in the environment in the tunnel; acquiring a temperature Tf around an outer surface of a windshield of the vehicle in an environment outside the tunnel or a vapor density Vf around the outer surface of the windshield of the vehicle in the environment outside the tunnel; and controlling the device so as to perform a prescribed operation when the temperature Tf is equal to or less than the dew point D or when the vapor density Vf is at least the saturated vapor density V.

Processing corresponding to the control method according to the embodiments disclosed herein can be performed by a CPU included in a computer. A program can be installed or loaded via various media, such as a CD-ROM, a magnetic disk, a semiconductor memory and a communication network.

Note that, in this specification, a “section” may be a unit realized by hardware, a unit realized by software or a unit realized using both thereof. One unit may be realized using two or more pieces of hardware. Two or more units may be realized by one piece of hardware.

### BRIEF DESCRIPTION OF THE DRAWINGS

FIG. 1 is a block diagram showing a schematic configuration of a control system 1 of a first embodiment;

FIG. 2A is a diagram showing a hardware configuration of an information processing unit 13 according to the first embodiment;

FIG. 2B is a diagram illustrating a functional configuration of the information processing unit 13 according to this embodiment;

FIG. 3 is a flowchart illustrating a process of addressing condensation according to the first embodiment;

FIG. 4 is a block diagram showing a schematic diagram of a control system 1′ of a second embodiment; and

FIG. 5 is a flowchart illustrating a process of addressing condensation according to the second embodiment.

### DETAILED DESCRIPTION

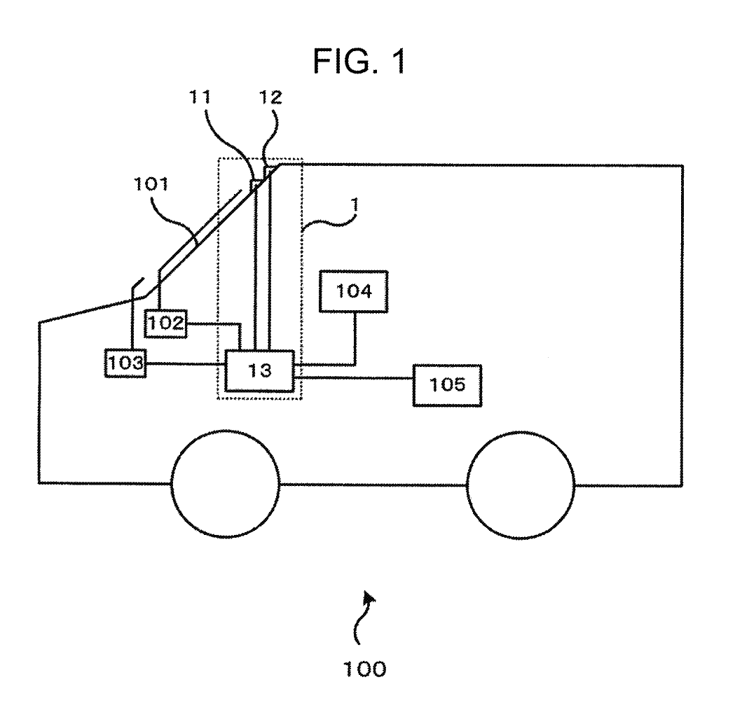

The Embodiments disclosed herein will hereinafter be described with reference to drawings. FIG. 1 is a diagram showing a schematic configuration of a control system 1 according to a first embodiment of this disclosure and a vehicle 100 in which the control system 1 is mounted.

As shown in FIG. 1, the control system 1 includes an onboard temperature sensor 11 and an onboard humidity sensor 12 which are attached around an outer surface of a windshield 101 of the vehicle 100 (e.g., around the top end of the outer surface of the windshield 101). The control system 1 also includes an information processing unit 13 mounted on the vehicle 100.

The vehicle 100 has a functional configuration similar to a conventional vehicle. For example, the vehicle 100 includes a windshield wiper device 102 and a windshield washer fluid ejector 103 both of which are examples of devices that are related to the windshield 101. Further, the vehicle 100 may include a car navigation system 104 including a display unit and a loudspeaker.

The onboard temperature sensor 11 and the onboard humidity sensor 12 are configured to measure a temperature and a humidity around the outer surface of the windshield 101, respectively, and to output measured data to the information processing unit 13. The onboard temperature sensor 11 and the onboard humidity sensor 12 can be realized using a conventional temperature sensor and a humidity sensor.

The information processing unit 13 is configured to perform a process of addressing condensation, which will be described later.

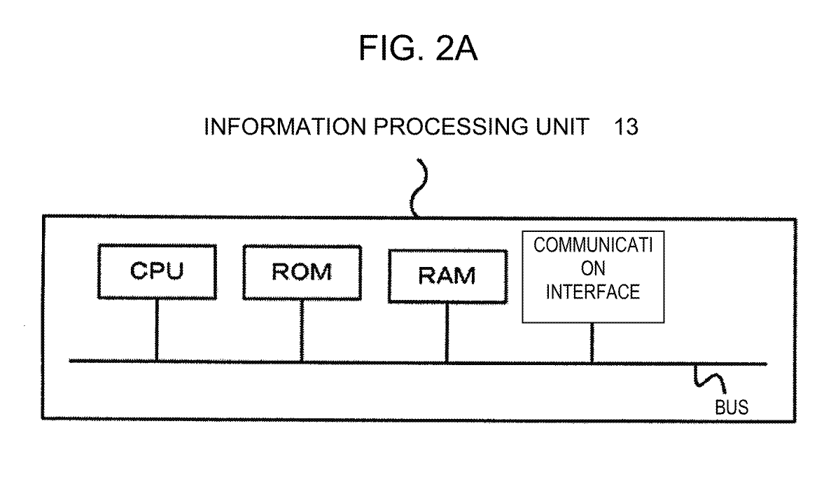

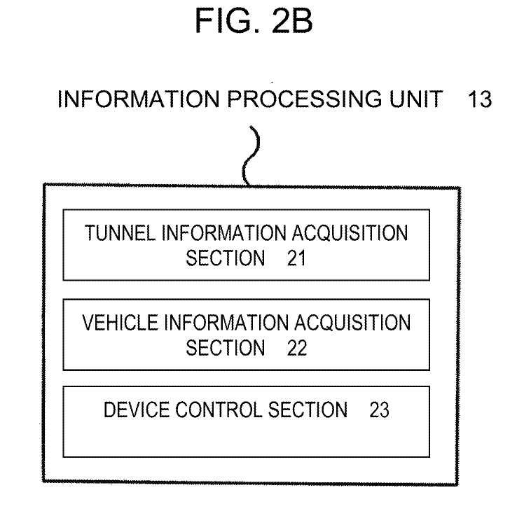

FIG. 2A is a block diagram showing a hardware configuration of the information processing unit 13. As shown in FIG. 2A, the information processing unit 13 includes hardware, such as a CPU, a memory (ROM and RAM) and a communication interface. The information processing unit 13 is configured to receive signals output from an electronic control unit 105 (FIG. 1), the car navigation system 104, the onboard temperature sensor 11, the onboard humidity sensor 12 and the like of the vehicle 100, and to output control signals to a controller of at least one device related to the windshield 101. Note that the information processing unit 13 may be configured using an integral circuit, such as an ASIC, instead of the CPU and the like.

FIG. 2B is a block diagram showing a functional configuration of the information processing unit 13. As shown in FIG. 2B, the information processing unit 13 includes functional means, such as a tunnel information acquisition section 21, a vehicle information acquisition section 22 and a device control section 23.

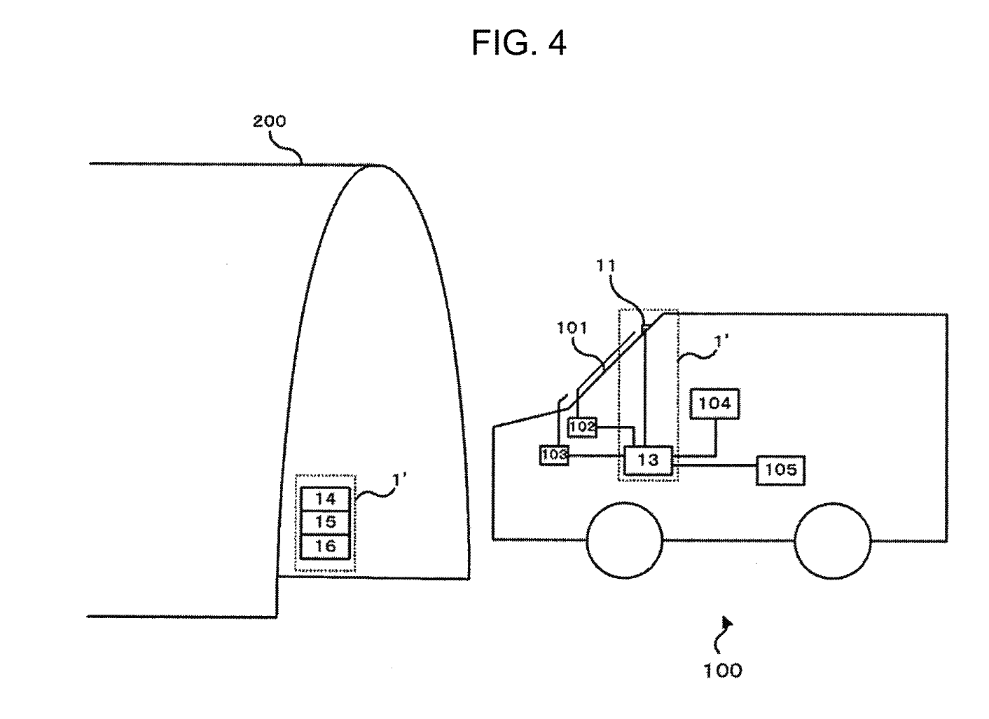

The tunnel information acquisition section 21 acquires a saturated vapor density V in an environment in a tunnel 200 (FIG. 4) through which the vehicle 100 can travel. More specifically, the tunnel information acquisition section 21 acquires a temperature Tt in the tunnel 200 on the basis of temperature data output from the onboard temperature sensor 11 and acquires the saturated vapor density V in the environment of the tunnel 200 on the basis of the temperature Tt, when the vehicle 100 enters in the tunnel 200.

The vehicle information acquisition section 22 acquires a vapor density Vf around the outer surface of the windshield 101 in an environment outside the tunnel 200. More specifically, before the vehicle 100 enters the tunnel 200, the vehicle information acquisition section 22 acquires a temperature Tf and a humidity Hf around the outside surface of the windshield 101 on the basis of sensor data output from the onboard temperature sensor 11 and the onboard humidity sensor 12, and calculates a vapor density Vf around the outer surface of the windshield 101 on the basis of the temperature Tf and the humidity Hf.

The device control section 23 determines whether condensation has occurred or not or determines whether there is a possibility of the occurrence of condensation on the basis of respective pieces of data acquired from the tunnel information acquisition section and the vehicle information acquisition section 22. The device control section 23 outputs a control signal indicating to a controller of at least one device mounted on the vehicle 100, for example a windshield wiper device, to perform a prescribed operation on the basis of the determination result.

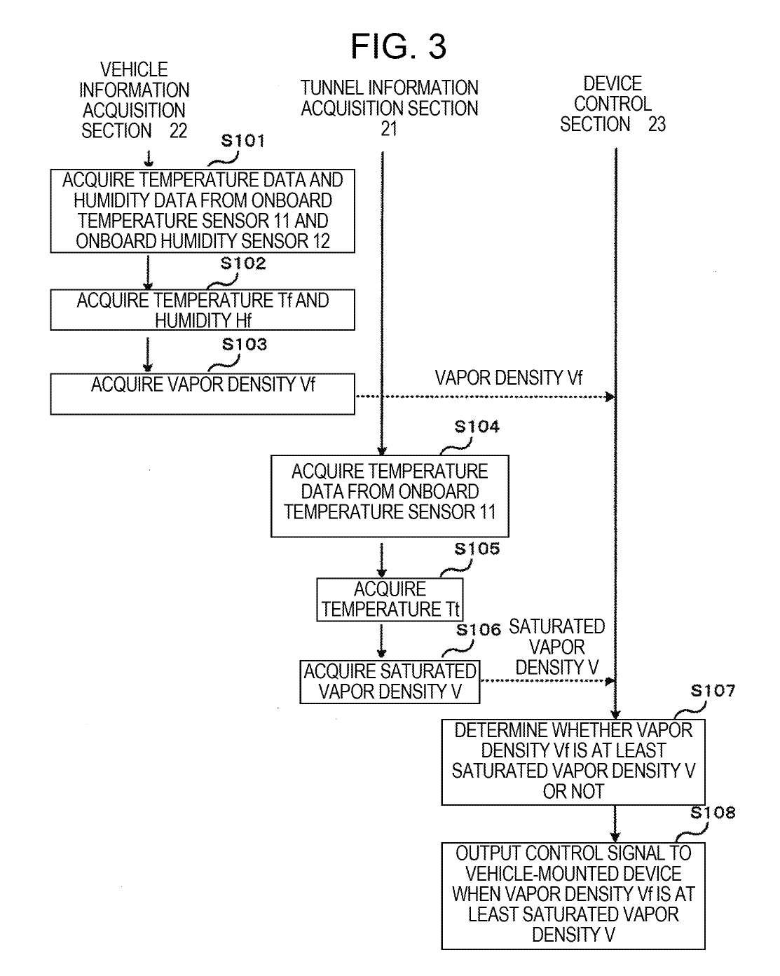

A framework for supporting driving using the control system 1 will be described on the basis of a flowchart shown in FIG. 3. Note that steps (including a partial step to which a symbol is not assigned) may be performed according to an arbitrarily changed order or in parallel to the extent that no contradiction is caused in processing details.

When the vehicle 100 is traveling outside and there is a tunnel 200 that the vehicle 100 is going to enter next on an expected course for traveling, the information processing unit 13 performs the following process of addressing condensation.

First, when it is determined that the vehicle 100 has not yet entered the tunnel 200, on the basis of, for example, information acquired from the car navigation system 104, the vehicle information acquisition section 22 acquires temperature data from the onboard temperature sensor 11 and acquires humidity data from the onboard humidity sensor 12 (S101).

Next, the vehicle information acquisition section 22 acquires a temperature Tf around the outer surface of the windshield 101 in the environment outside of the tunnel 200 on the basis of temperature data acquired from the onboard temperature sensor 11, and acquires a humidity Hf around the outer surface of the windshield 101 in the environment outside the tunnel 200 on the basis of humidity data acquired from the onboard humidity sensor 12 (S102). For example, respective pieces of data acquired from the onboard temperature sensor 11 and the onboard humidity sensor 12 for a certain time period while the vehicle is traveling outside the tunnel are averaged and the averaged values can be acquired as the temperature Tf and the humidity Hf.

Next, the vehicle information acquisition section 22 calculates the vapor density Vf around the outer surface of the windshield 101 in the environment outside the tunnel 200 on the basis of the temperature Tf and the humidity Hf (S103). For example, a table holding a correspondence between the temperature and the saturated vapor density is preliminarily stored. The saturated vapor density at the temperature Tf is acquired by referring to this table. The vapor density Vf can be calculated from the saturated vapor density and the humidity Hf.

Next, when it is determined that the vehicle 100 has entered the tunnel 200 on the basis of, for example, information acquired from the car navigation system 104, the tunnel information acquisition section 21 acquires temperature data from the onboard temperature sensor 11 (S104).

Next, the tunnel information acquisition section 21 acquires the temperature around the outer surface of the windshield 101 in the environment in the tunnel 200 on the basis of the temperature data acquired from the onboard temperature sensor 11 (S105). In the first embodiment, the temperature around the outer surface of the windshield 101 in the environment in the tunnel 200 is used as the temperature Tt.

In order to acquire the temperature Tt in a short time period after entrance into the tunnel, the temperature around the outer surface of the windshield 101 in a stationary state when traveling in the tunnel may be predicted from temporal changes of the temperature data from the onboard temperature sensor 11. This prediction may occur before measured results from the onboard temperature sensor 11 become stationary. This prediction may be used as the temperature Tt. A conventional prediction technique may be used for such a prediction.

Next, the tunnel information acquisition section 21 acquires the saturated vapor density V in the environment in the tunnel on the basis of the temperature Tt (S106). For example, the table including the correspondence between the aforementioned temperature and the saturated vapor density is referred and the saturated vapor density V at the temperature Tt can be acquired.

Next, the device control section 23 determines whether condensation has occurred on the outer surface of the windshield 101 or, if not, if there is a possibility of an occurrence of condensation, while the vehicle is traveling in the tunnel 200. This determination is based on the vapor density Vf calculated by the vehicle information acquisition section 22 and the saturated vapor density V acquired by the tunnel information acquisition section 21 (S107). More specifically, it is determined whether the vapor density Vf is at least the same as the saturated vapor density V or not. When the vapor density Vf is smaller than the saturated vapor density V, it is determined that condensation has not occurred on the outer surface of the windshield 101 and there is no possibility of occurrence. In this case, the process of addressing condensation is finished with respect to the tunnel 200 as the determination target.

On the other hand, when the vapor density Vf is at least the same as the saturated vapor density V, the device control section 23 determines that condensation has occurred on the outer surface of the windshield 101 or that there is a possibility of an occurrence. The device control section 23 outputs a control signal indicating to at least one device mounted on the vehicle 100 to perform a prescribed operation (S108).

For example, when the device control section 23 outputs the control signal to the controller of the windshield wiper device 102, the device control section 23 outputs a control signal for driving the windshield wiper of the windshield 101 for a prescribed time period or prescribed time periods. Subsequently, the process of addressing condensation is finished with respect to the tunnel 200 as the determination target. The windshield wiper device 102 operates the windshield wiper on the basis of such a control signal. As a result, the condensation occurring on the windshield 101 is removed and occurrence of the condensation is prevented.

FIG. 4 is a diagram showing a schematic configuration of a control system 1′ according to a second embodiment of this disclosure and a vehicle 100 in which the control system 1′ is mounted. As shown in FIG. 4, the control system 1′ includes an onboard temperature sensor 11 mounted around the outer surface of the windshield 101 of the vehicle 100 (e.g., around the top end of the windshield 101), and an information processing unit 13 mounted on the vehicle 100.

The control system 1′ includes an in-tunnel temperature sensor 14, an in-tunnel humidity sensor 15 and a data transmitting unit 16 that are disposed in the tunnel 200 as a determination target of a process of addressing condensation. In principle, the vehicle 100 and the onboard temperature sensor 11 are analogous to those of the first embodiment.

The information processing unit 13 includes a hardware configuration and a functional configuration analogous to those of the first embodiment shown in FIG. 2. However, there are differences from the first embodiment. For example, the vehicle information acquisition section 22 and the tunnel information acquisition section 21 acquire a temperature Tf and a dew point D instead of the vapor density Vf and the saturated vapor density V. Further, the tunnel information acquisition section 21 acquires sensor data of the in-tunnel temperature sensor 14 or the like instead of the sensor data of the onboard temperature sensor 11.

The in-tunnel temperature sensor 14 and the in-tunnel humidity sensor 15 are configured to measure a temperature and a humidity in the tunnel 200, respectively, and output the measured data to the data transmitting unit 16. Such in-tunnel temperature sensor 14 and the in-tunnel humidity sensor 15 can be realized using a conventional temperature sensor and humidity sensor.

The data transmitting unit 16 transmits respective pieces of sensor data of the in-tunnel temperature sensor 14 and the in-tunnel humidity sensor 15 to an external wireless base station or the like such that the information processing unit 13 (tunnel information acquisition section 21) can acquire the data. Such a data transmitting unit 16 can be realized using a conventional wireless transmitting unit.

For example, the pieces of the sensor data transmitted to the external wireless base station can be received by an onboard wireless communication device of the vehicle 100 via a communication network, and output from the onboard wireless communication device to the information processing unit 13. The control system 1′ may include a wireless communication section. A configuration may be employed where the information processing unit 13 receives the sensor data transmitted from the data transmitting unit 16 via such a wireless communication section.

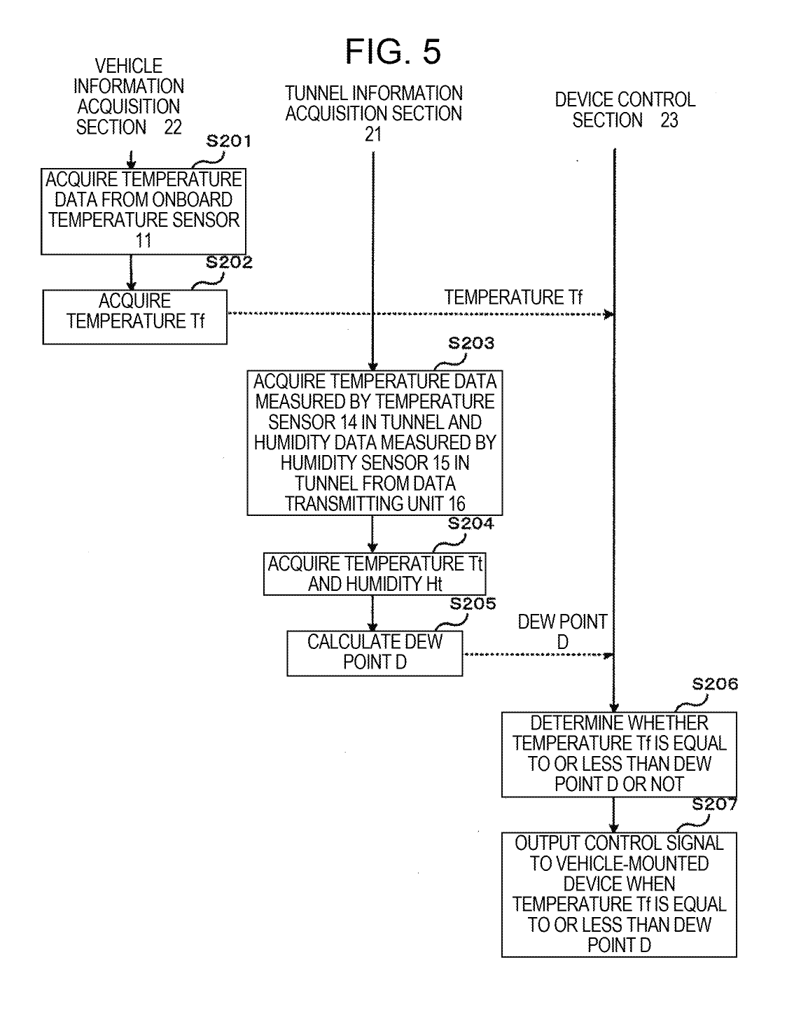

A framework for supporting driving that is realized using the control system 1′ will hereinafter be described on the basis of a flowchart shown in FIG. 5. Note that steps (including a partial step to which a symbol is not assigned) may be performed according to an arbitrarily changed order or in parallel to the extent that no contradiction is caused in processing details.

When the vehicle 100 is traveling outside and there is a tunnel 200 that the vehicle 100 is going to enter next on an expected course for traveling, the information processing unit 13 performs the following process of addressing condensation.

First, when it is determined the vehicle 100 has not yet entered the tunnel 200 on the basis of, for example, information acquired from the car navigation system 104, the vehicle information acquisition section 22 acquires temperature data from the onboard temperature sensor 11 (S201).

Next, the vehicle information acquisition section 22 acquires a temperature Tf around the outer surface of the windshield 101 in the environment outside the tunnel 200 on the basis of temperature data acquired from the onboard temperature sensor 11 (S202). For example, when traveling outside of the tunnel, the temperature data acquired from the onboard temperature sensor 11 for a certain time period is averaged and can be acquired as the temperature Tf.

On the other hand, when it is determined that the vehicle 100 has not yet entered the tunnel 200 or has just entered the tunnel 200 on the basis of, for example, information acquired from the car navigation system 104, the tunnel information acquisition section 21 acquires the temperature data measured by the in-tunnel temperature sensor 14 and the humidity data measured by the in-tunnel humidity sensor 15 from the data transmitting unit 16 disposed in the tunnel 200 via the wireless base station and the like (S203).

Next, the tunnel information acquisition section 21 acquires the temperature Tt in the tunnel 200 on the basis of the temperature data measured by the in-tunnel temperature sensor 14, and acquires the humidity Ht in the tunnel 200 on the basis of the humidity data measured by the in-tunnel humidity sensor 15 (S204). The in-tunnel temperature sensor 14 and the in-tunnel humidity sensor 15 are typically capable of measuring the temperature and the humidity in a stationary state in the environment in the tunnel 200. Accordingly, in the second embodiment, the temperature data measured by the in-tunnel temperature sensor 14 is used as the temperature Tt in the tunnel 200 without being subjected to processing and the humidity data measured by the in-tunnel humidity sensor 15 is used as the humidity Ht in the tunnel 200 without being subjected to processing.

Next, the tunnel information acquisition section 21 calculates a dew point D in the environment in the tunnel 200 on the basis of the temperature Tt and the humidity Ht (S205). For example, a table showing a correspondence between the temperature and the saturated vapor density is preliminarily stored, the table is referred to and the saturated vapor density at the temperature Tt is acquired. The vapor density in the tunnel is then calculated from the saturated vapor density and the humidity Ht. The table is again referred to and the temperature at which the calculated vapor density in the tunnel is associated with the saturated vapor density can be extracted as the dew point D.

Next, the device control section 23 determines whether condensation has occurred on the outer surface of the windshield 101 or, if not, whether there is a possibility of an occurrence of condensation while the vehicle is traveling in the tunnel 200. This determination is made on the basis of the temperature Tf acquired by the vehicle information acquisition section 22 and the dew point D acquired by the tunnel information acquisition section 21 (S206). More specifically, it is determined whether the temperature Tf is equal to or less than the dew point D or not. When the temperature Tf is larger than the dew point D, it is determined that condensation has not occurred on the outer surface of the windshield 101 or that there is no possibility of an occurrence of condensation. In this case, the process of addressing condensation is finished with respect to the tunnel as the determination target.

On the other hand, if the temperature Tf is equal to or less than the dew point D, the device control section 23 determines that condensation has occurred on the outer surface of the windshield 101 or that there is a possibility of an occurrence of condensation. The control section 23 then outputs a control signal indicating to at least one device mounted on the vehicle 100 to perform a prescribed operation (S207).

For example, the device control section 23 outputs the control signal to the controller of the windshield washer fluid ejector 103 instructing the windshield washer fluid ejector 103 to eject windshield washer fluid onto the windshield 101. Subsequently, the process of addressing condensation is finished with respect to the tunnel as the determination target. The windshield washer fluid ejector 103 ejects the windshield washer fluid on the basis of the received control signal. As a result, condensation caused on the windshield 101 is removed and occurrence of condensation is prevented.

The embodiments disclosed herein are not limited to the above embodiments. Rather, various modifications, additions and abbreviations may be made by a person skilled in the art without departing from the spirit and scope described in the claims. For example, the elements of the first and second embodiments may be arbitrarily combined and implemented to the extent that no contradictions are caused.

As one example, in the first embodiment, the windshield washer fluid ejector 103 may be a control target device of the device control section 23. Likewise, in the second embodiment, the windshield wiper device 102 may be the control target device. Further, in the first and second embodiments, both of the windshield wiper device 102 and the windshield washer fluid ejector 103 may be the control target devices.

Further, in addition to or instead of the windshield wiper device 102 and the windshield washer fluid ejector 103, another device mounted on the vehicle 100 may be controlled to perform a prescribed operation. For example, in a case of utilizing the car navigation system 104 as an alarm device, the car navigation system 104 may be controlled to display an alarm message on a display and output an alarm sound from a loudspeaker in order to alert a driver and other passengers about a possibility of condensation on the windshield 101.

In particular, as with the second embodiment, in a case where the tunnel information acquisition section 21 acquires the temperature data and the humidity data before the vehicle 100 enters the tunnel 200, the device control section 23 can determine before the vehicle 100 enters the tunnel 200 whether or not there is a possibility of an occurrence of condensation on the outer surface of the windshield 101 when the vehicle enters the tunnel. This allows the alarm device to be controlled to alert the driver and the other passengers before entrance into the tunnel 200.

Further, for example, as with the second embodiment, the first embodiment may employ a configuration where the in-tunnel temperature sensor 14, the data transmitting unit 16 and the like are arranged in the tunnel. The tunnel information acquisition section 21 may acquire the temperature data measured by the in-tunnel temperature sensor 14 from the data transmitting unit 16, thereby acquiring the saturated vapor density V on the basis of the temperature data from the in-tunnel temperature sensor 14.

Further, for example, as with the first embodiment, the second embodiment may employ a configuration where, when the tunnel information acquisition section 21 determines that the vehicle 100 has entered into the tunnel, the temperature Tt and the humidity Ht in the tunnel are acquired on the basis of the temperature data acquired from the onboard temperature sensor 11 and the humidity data acquired from the onboard humidity sensor 12.

Moreover, for example, the second embodiment may employ a configuration where a dew point meter is disposed around the outer surface of the windshield 101 or in the tunnel that is the determination target of the process of addressing condensation, and the tunnel information acquisition section 21 acquires the dew point D on the basis of measurement data from the dew point meter.

In addition, for example, a configuration may be employed where the dew point or the temperature and humidity are preliminarily measured in the tunnel and the results thereof are stored in a database. The information processing unit 13 may read the database and acquire the dew point D in the tunnel that is the determination target of the process of addressing condensation, or read out the temperature Tt and the humidity Ht of the tunnel and calculate the dew point D.

Moreover, for example, a configuration may be employed where the saturated vapor density or the temperature is preliminarily measured in the tunnel and the results thereof are stored in the database. The information processing unit 13 may read the database and acquire the saturated vapor density V in the tunnel that is the determination target of the process of addressing condensation, or read out the temperature Tt of the tunnel and acquire the saturated vapor density V.

The database may be mounted on the vehicle 100 as a part of the control system 1 or 1′ or may be an external device of the control system 1 or 1′. Further, in a case where the information processing unit 13 is capable of accessing the database, the database may be disposed outside of the vehicle 100.

Moreover, for example, a configuration may be employed where the data transmitting unit 16 averages the sensor data of the in-tunnel temperature sensor 14 or the in-tunnel humidity sensor 15 and thereby acquires the temperature Tt or the humidity Ht, and transmits the temperature Tt or the humidity Ht to the information processing unit 13. Further, a configuration may be employed where the data transmitting unit 16 calculates the dew point D from the temperature Tt and the humidity Ht, and transmits the dew point D to the information processing unit 13.

In addition, for example, each sensor and each unit may employ any one of a configuration of operating by an internal power source, and a configuration of operating by being supplied with power from a power source disposed in the vehicle 100 or the tunnel.

The technical characteristics of the embodiments and various modifications thereof having been described above may be arbitrarily combined and employed.

What is claimed is:

1. A control system of a device mounted on a vehicle, comprising:
a tunnel information acquisition section adapted to acquire a saturated vapor density V in an environment of a tunnel where the vehicle can travel;
a vehicle information acquisition section adapted to acquire a vapor density Vf around an outer surface of a windshield of the vehicle in an environment outside the tunnel;
a control section adapted to control the device so as to perform a prescribed operation when the vapor density Vf is at least the same as the saturated vapor density V; and
an onboard temperature sensor and an onboard humidity sensor disposed around an outer surface of the windshield of the vehicle.

2. The control system according to claim 1, wherein the vehicle information acquisition section is adapted to:
acquire a temperature Tf around the outer surface of the windshield of the vehicle on the basis of sensor data from the onboard temperature sensor;
acquire a humidity Hf around the outer surface of the windshield of the vehicle on the basis of sensor data from the onboard humidity sensor before the vehicle enters the tunnel; and
calculate the vapor density Vf on the basis of the temperature Tf and the humidity Hf.

3. The control system according to claim 2, wherein the tunnel information acquisition section is adapted to:
acquire a temperature Tt in the tunnel on the basis of the sensor data from the onboard temperature sensor; and
acquire the saturated vapor density V on the basis of the temperature Tt when the vehicle enters the tunnel.

4. The control system according to claim 3, further comprising at least one of a windshield wiper driver related to the windshield of the vehicle, a windshield washer fluid ejector related to the windshield of the vehicle, and an alarm device for an occupant of the vehicle.

5. A control system of a device mounted on a vehicle, comprising:
a tunnel information acquisition section adapted to acquire a dew point D in an environment in a tunnel where the vehicle can travel or acquire a saturated vapor density V in the environment in the tunnel;
a vehicle information acquisition section adapted to acquire a temperature Tf around an outer surface of a windshield of the vehicle in an environment outside the tunnel or acquire a vapor density Vf around the outer surface of the windshield of the vehicle in the environment outside the tunnel; and
a control section adapted to control the device so as to perform a prescribed operation when the temperature Tf is equal to or less than the dew point D or when the vapor density Vf is at least the same as the saturated vapor density V.

6. The control system according to claim 5, wherein the tunnel information acquisition section is adapted to:
acquire a temperature Tt and a humidity Ht in the tunnel, and
calculate the dew point D on the basis of the temperature Tt and the humidity Ht.

7. The control system according to claim 5, further comprising:
an in-tunnel temperature sensor and an in-tunnel humidity sensor disposed in the tunnel; and
a transmitting unit adapted to transmit sensor data of the in-tunnel temperature sensor and the in-tunnel humidity sensor such that the tunnel information acquisition section can acquire the sensor data,
wherein the tunnel information acquisition section is adapted to:
acquire the sensor data transmitted from the transmitting unit; and
acquire the temperature Tt and the humidity Ht on the basis of the sensor data.

8. The control system according to claim 5, wherein the tunnel information acquisition section is adapted to:
acquire a temperature Tt in the tunnel; and
calculate the saturated vapor density V on the basis of the temperature Tt.

9. The control system according to claim 8, further comprising:
an in-tunnel temperature sensor disposed in the tunnel; and
a transmitting unit adapted to transmit sensor data from the in-tunnel temperature sensor such that the tunnel information acquisition section can acquire the sensor data,
wherein the tunnel information acquisition section is adapted to acquire the sensor data transmitted from the transmitting unit and acquire the saturated vapor density V on the basis of the sensor data.

10. The control system according to claim 5, further comprising:
an onboard temperature sensor and an onboard humidity sensor disposed around an outer surface of the windshield of the vehicle,
wherein the vehicle information acquisition section is adapted to:
acquire a temperature Tf around an outer surface of the windshield of the vehicle on the basis of sensor data from the onboard temperature sensor;
acquire a humidity Hf around the outer surface of the windshield of the vehicle on the basis of sensor data from the onboard humidity sensor before the vehicle enters the tunnel; and
calculate a vapor density Vf on the basis of the temperature Tf and the humidity Hf.

11. The control system according to claim 10, wherein the tunnel information acquisition section is adapted to:
acquire a temperature Tt in the tunnel on the basis of the sensor data from the onboard temperature sensor; and
acquire the saturated vapor density V on the basis of the temperature Tt when the vehicle enters the tunnel.

12. The control system according to claim 5, further comprising:
an onboard temperature sensor and an onboard humidity sensor disposed around an outer surface of the windshield of the vehicle;
wherein the vehicle information acquisition section is adapted to acquire a temperature Tf around the outer surface of the windshield of the vehicle on the basis of sensor data from the onboard temperature sensor before the vehicle enters the tunnel.

13. The control system according to claim 12, wherein the tunnel information acquisition section is adapted to:
acquire a temperature Tt in the tunnel on the basis of the sensor data from the onboard temperature sensor;
acquire a humidity Ht in the tunnel on the basis of the sensor data from the onboard humidity sensor; and
calculate the dew point D on the basis of the temperature Tt and the humidity Ht when the vehicle enters the tunnel.

14. The control system according to claim 5, further comprising:
a database storing data of the dew point in the tunnel that is preliminarily measured or storing data of a temperature and a humidity in the tunnel that is preliminarily measured;
wherein the tunnel information acquisition section is adapted to acquire the dew point D on the basis of data read from the database.

15. The control system according to claim 5, further comprising:
a database storing data of the saturated vapor density in the tunnel that is preliminarily measured or storing data of a temperature in the tunnel that is preliminarily measured;
wherein the tunnel information acquisition section is adapted to acquire the saturated vapor density V on the basis of data read from the database.

16. The control system according to claim 5, wherein the device comprises at least one of a windshield wiper device related to the windshield of the vehicle, a windshield washer fluid ejector related to the windshield of the vehicle, and an alarm device notifying an alarm to an occupant of the vehicle.

17. A vehicle including a control system and a control target device comprising:
a tunnel information acquisition section adapted to acquire a dew point D in an environment in a tunnel where the vehicle can travel or acquire a saturated vapor density V in the environment in the tunnel;
a vehicle information acquisition section adapted to acquire a temperature Tf around an outer surface of a windshield of the vehicle in an environment outside the tunnel or acquire a vapor density Vf around the outer surface of the windshield of the vehicle in the environment outside the tunnel; and
a control section adapted to control the control target device so as to perform a prescribed operation when the temperature Tf is equal to or less than the dew point D or when the vapor density Vf is at least the same as the saturated vapor density V.

18. The vehicle according to claim 17, further comprising an onboard temperature sensor and an onboard humidity sensor disposed around an outer surface of the windshield of the vehicle.

19. The vehicle according to claim 18, further comprising at least one of a windshield wiper driver related to the windshield of the vehicle, a windshield washer fluid ejector related to the windshield of the vehicle, and an alarm device for an occupant of the vehicle.

20. A control method for a device mounted on a vehicle as a control target, including:
acquiring a dew point D in an environment in a tunnel where the vehicle can travel or a saturated vapor density V in the environment in the tunnel;
acquiring a temperature Tf around an outer surface of a windshield of the vehicle in an environment outside the tunnel or a vapor density Vf around the outer surface of the windshield of the vehicle in the environment outside the tunnel; and
controlling the device so as to perform a prescribed operation when the temperature Tf is equal to or less than the dew point D or when the vapor density Vf is at least the saturated vapor density V.
